(19) United States
(12) Patent Application Publication
(10) Pub. No.: US 2013/0196224 A1
(43) Pub. Date: Aug. 1, 2013

(54) Intermediate Temperature Sodium Metal-Halide Energy Storage Devices

(71) Applicant: BATTELLE MEMORIAL INSTITUTE, Richland, WA (US)

(72) Inventors: Jin Yong Kim, Richland, WA (US); Guosheng Li, Richland, WA (US); Xiaochuan Lu, Richland, WA (US); Vincent L. Sprenkle, Richland, WA (US); John P. Lemmon, Kennewick, WA (US); Zhenguo Yang, Bellevue, WA (US); Christopher A. Coyle, Pasco, WA (US)

(73) Assignee: BATTELLE MEMORIAL INSTITUTE, Richland, WA (US)

(21) Appl. No.: 13/752,936

(22) Filed: Jan. 29, 2013

Related U.S. Application Data
(60) Provisional application No. 61/593,499, filed on Feb. 1, 2012.

(51) Int. Cl. H01M 10/0563

(52) U.S. Cl. CPC H01M 10/0563
USPC 429/199

(57) ABSTRACT

Sodium metal-halide energy storage devices utilizing a substituting salt in its secondary electrolyte can operate at temperatures lower than conventional ZEBRA batteries while maintaining desirable performance and lifetime characteristics. According to one example, a sodium metal-halide energy storage device operates at a temperature less than or equal to 200° C. and has a liquid secondary electrolyte having MₓNa_{1-y}AlCl_{4-y}H_{y}, wherein M is a metal cation of a substituting salt, H is an anion of the substituting salt, y is a mole fraction of substituted Na and Cl, and x is a ratio of y over r, where r is the oxidation state of M. The melting temperature of the substituting salt is less than that of NaCl.

### CROSS-REFERENCE TO RELATED APPLICATIONS

This invention claims priority from U.S. provisional patent application 61/593,499 entitled Energy Storage Device Having Sodium, filed Feb. 1, 2012. The provisional application is incorporated herein by reference.

### STATEMENT REGARDING FEDERALLY SPONSORED RESEARCH OR DEVELOPMENT

This invention was made with Government support under Contract DE-AC0576RLO1830 awarded by the U.S. Department of Energy. The Government has certain rights in the invention.

### BACKGROUND

Among the several types of Zebra batteries (i.e., sodium metal chloride batteries), the most widely investigated type is based on a nickel-containing chemistry, which is typically fabricated in a tubular form with β″-alumina solid electrolyte (BASE) tube. Cathode materials typically consist of electrochemically active ingredients (e.g., nickel and sodium chloride in the discharged state) and a molten salt secondary electrolyte (or catholyte) such as NaAlCl₄ which ensures facile sodium ion transport between the BASE and active cathode materials. In some instances, a small amount of additives such as NaF, FeS, and Al are also added to the cathode to minimize the degradation of battery performance caused by overcharge abuse, grain growth of nickel, and sudden polarization drop at the end of discharge.

The ZEBRA battery is usually operated at relatively high temperatures (250˜350° C.), which is well above the melting point of the liquid electrolyte (NaAlCl₄: Tₘ=157° C.), in order to achieve adequate battery performance by reducing the ohmic resistance of the BASE and by improving the ionic conductivity of the secondary electrolyte. However, particle growth and side reactions occurring in the cathode are also enhanced at high operating temperatures and can result in degradation of performance and/or lifetime. Therefore, an improved ZEBRA energy storage device that operates at lower temperatures is needed.

### SUMMARY

This document describes sodium metal-halide energy storage devices that can operate at temperatures lower than conventional ZEBRA batteries while maintaining desirable performance and lifetime characteristics. The reduced operating temperature exhibited by embodiments described herein can also allow for the use of lower cost materials of construction and high throughput manufacturing methods.

According to one embodiment, a sodium metal-halide energy storage device operates at intermediate temperatures less than or equal to 200° C. and has a liquid secondary electrolyte comprising MₓNa_{1-y}AlCl_{4-y}H_{y}, wherein M is a metal cation of a substituting salt, H is an anion of the substituting salt, y is a mole fraction of substituted Na and Cl, and x is a ratio of y over r, where r is the oxidation state of M. The melting temperature of the substituting salt is less than that of NaCl.

Examples of the substituting salt can include, but are not limited to, NaBr, LiCl, LiBr, NaI, LiI, KBr, KCl, KI, CsBr, and CsI. Preferably, the substituting salt includes, but is not limited to, NaBr, LiCl, or LiBr. In some embodiments, the mole fraction of substituted Na and Cl is less than 0.85. In other embodiments, the mole fraction of substituted Na and Cl is less than or equal to 0.75.

The energy storage devices described herein can further comprise cathode and anode chambers. The cathode chamber, the anode chamber, or both can have seals that comprise a polymer material. Examples of primary electrolytes can include, but are not limited to β″-alumina solid electrolyte (BASE) or sodium super ion conductors (NaSICON).

The purpose of the foregoing summary is to enable the United States Patent and Trademark Office and the public generally, especially the scientists, engineers, and practitioners in the art who are not familiar with patent or legal terms or phraseology, to determine quickly from a cursory inspection the nature and essence of the technical disclosure of the application. The summary is neither intended to define the invention of the application, which is measured by the claims, nor is it intended to be limiting as to the scope of the invention in any way.

Various advantages and novel features of the present invention are described herein and will become further readily apparent to those skilled in this art from the following detailed description. In the preceding and following descriptions, the various embodiments, including the preferred embodiments, have been shown and described. Included herein is a description of the best mode contemplated for carrying out the invention. As will be realized, the invention is capable of modification in various respects without departing from the invention. Accordingly, the drawings and description of the preferred embodiments set forth hereafter are to be regarded as illustrative in nature, and not as restrictive.

### DESCRIPTION OF DRAWINGS

Embodiments of the invention are described below with reference to the following accompanying drawings.

FIG. 1 is a graph plotting the melting temperature of a NaAlCl₄ secondary electrolyte as a function of mole fraction of a substituting salt that replaces NaCl.

FIGS. 2A and 2B is a graph plotting ionic conductivity of various secondary electrolytes.

FIG. 3 includes Cyclic voltammograms of NaAlCl₄ having 50 mol % replaced secondary electrolytes measured at 190° C., according to embodiments of the present invention.

FIG. 4A-4C includes plots of charge-discharge voltage as a function of the state of charge (SOC); (a) at 280° C. [maiden charge and discharge down to 20% SOC], (b) at 175° C. [cycled between 20˜80% SOC], and (c) at 150° C. [only 80 mAh was cycled due to the voltage limitation of charge].

FIG. 5 includes impedance spectra of cells comprising a NaAlCl₄ and NaBr-50 secondary electrolyte.

FIGS. 6A and 6B summarize the electrochemical performance of a cell having a secondary electrolyte comprising NaBr-50 as a substituting salt. The cell was operated at 150° C.: (a) capacity vs. cycle and (b) end voltage vs. cycle. The cycling capacity was 80 mAh.

### DETAILED DESCRIPTION

The following description includes the preferred best mode of one embodiment of the present invention. It will be clear from this description of the invention that the invention is not limited to these illustrated embodiments but that the invention also includes a variety of modifications and embodiments thereto. Therefore the present description should be seen as illustrative and not limiting. While the invention is susceptible of various modifications and alternative constructions, it should be understood, that there is no intention to limit the invention to the specific form disclosed, but, on the contrary, the invention is to cover all modifications, alternative constructions, and equivalents falling within the spirit and scope of the invention as defined in the claims.

A sodium-nickel chloride (ZEBRA) battery is typically operated at relatively high temperature (e.g., approximately 250 to 350° C.) to achieve adequate electrochemical performance. Reducing the operating temperature, even to values below 200° C., can lead to enhanced cycle life by suppressing temperature-related degradation mechanisms. The reduced temperature range can also allow for lower cost materials of construction such as polymer, or elastomeric, sealants and gaskets. To achieve adequate electrochemical performance at lower operating temperatures can involve an overall reduction in ohmic losses associated with temperature. This can include reducing the ohmic resistance of β″-alumina solid electrolyte (BASE) and the incorporation of a low melting point molten salt as the secondary electrolyte.

In the examples below, planar-type Na/NiCl₂ cells with a thin flat plate BASE (600 μm) and low melting point secondary electrolyte were operated at reduced temperatures. Molten salt formulations, for use as secondary electrolytes, were fabricated by partially replacing NaCl in the traditional secondary electrolyte, NaAlCl₄, with a substituting salt. Electrochemical characterization of the resulting ternary molten salts demonstrated improved ionic conductivity and a sufficient electrochemical window at reduced temperatures. Many of the cells also exhibited reduced polarizations at lower temperatures compared to the control cell having standard NaAlCl₄ catholyte. The cells also exhibited stable cycling performance even at 150° C.

As used herein, a substituting salt refers to an alkali metal salt having a melting point that is lower than NaCl. In many instances, the substituting salts are known to possess weaker ionic bond strength than NaCl.

In one embodiment, the melting temperature of the secondary electrolyte, NaCl in NaAlCl₄ was partially replaced (0˜75 mol % replacement) with NaBr (Tₘ=747° C.), LiCl (Tₘ=605° C.), or LiBr (Tₘ=505° C.), each of which has a lower melting temperature than NaCl (Tₘ=801° C.). High-purity alkali metal salts (>99.99%) and anhydrous AlCl₃ (≧99.99%) were used to synthesize lower melting temperature secondary electrolytes. Briefly, alkali metal salts (i.e., a mixture of NaCl and a substituting salt) and AlCl₃ were mixed in the molar ratio of 1.15 to 1 and homogenized at 320° C. in a three neck flask which was purged with ultra-high purity (UHP) argon. An excess of alkali metal salts was employed to prevent the formation of Lewis-acid melts whose molar ratio of alkali metals to Al is less than 1. A high purity aluminum foil was added during the homogenization to remove possible impurities. Elemental analysis confirmed that the level of impurities was less than 5 ppm. The melting temperature of as-synthesized secondary electrolytes was measured using a capillary melting point analyzer in the temperature range of 80° C. to 200° C. at a heating rate of 3° C./min. The nomenclature and composition of each synthesized catholyte is listed in Table 1. The corresponding mol % of the salt substituted for NaCl is also shown.

TABLE 1
The nomenclature and composition of secondary electrolytes

| Salt | 25 mol % replacement | 50 mol % replacement | 75 mol % replacement |
|---|---|---|---|
| NaBr | NaBr-25 | NaBr-50 | NaBr-75 |
| | (NaBr_{0.25}NaCl_{0.75}AlCl₃) | (NaBr_{0.5}NaCl_{0.5}AlCl₃) | (NaBr_{0.75}NaCl_{0.25}AlCl₃) |
| LiCl | LiCl-25 | LiCl-50 | LiCl-75 |
| | (LiClr_{0.25}NaCl_{0.75}AlCl₃) | (LiClr_{0.5}NaCl_{0.5}AlCl₃) | (LiClr_{0.75}NaCl_{0.25}AlCl₃) |
| LiBr | LiBr-25 | LiBr-50 | LiBr-75 |
| | (LiBrr_{0.25}NaCl_{0.75}AlCl₃) | (LiBrr_{0.5}NaCl_{0.5}AlCl₃) | (LiBrr_{0.75}NaCl_{0.25}AlCl₃) |

Measurements of ionic conductivity and the electrochemical window were conducted in an argon-filled glove box. The ionic conductivity of molten catholytes was measured using an impedance analyzer in the frequency range of 1 MHz to 0.05 Hz. The impedance measurements were performed at a series of temperatures from 150° C. to 250° C. using a two-probe method. The probe was made of two platinum foils (3 mm×3 mm) that were glass sealed on a rectangular alumina rod. Each probe was calibrated using three standard solutions (1M, 0.1 M, and 0.01 M KCl aqueous solutions) to obtain accurate conductivities.

The electrochemical window of secondary electrolytes was measured in a three-electrode cell using a potentiostat (Solartron 1287A). An molybdenum wire (0.5 mm OD) and foil (5 mm×10 mm) was used as the working and counter electrodes, respectively, while an aluminum wire submerged in a borosilicate glass tube filled with an AlCl₃-saturated [EMIM]⁺Cl⁻ solution was used as a reference electrode. Cyclic voltammograms were collected at the scan rate of 50 mV/s between 0 and 2.8 V with respect to the Al/Al³⁺ reference electrode.

Planar Na/NiCl₂ cells were assembled in a glove box, following a procedure described below. First, a planar BASE disc was glass-sealed to an α-alumina ring. Cathode granules comprising Ni, NaCl and small amounts of additives were then poured into a cathode chamber on the α-alumina ring and dried at 270° C. under vacuum to remove all traces of moisture. After vacuum drying, molten catholyte was infiltrated into the cathode. A foil and a spring made of Mo were placed on the top of the cathode as a current collector. A spring-loaded stainless steel shim, which served as a molten sodium reservoir, was inserted into the anode compartment. Anode and cathode end plates were then compression-sealed to both sides of α-alumina ring using gold o-rings. Nickel leads, which served as current collectors, were welded to the electrode end plates. The assembled cell was initially charged up to 2.8 V at 280° C. to obtain the full theoretical capacity (˜150 mAh) at the constant current of 10 mA and discharged back to 80% of the initial maiden charge capacity. The cell was then cooled down to 175° C. and 150° C. and cycled between 20 and 80% state of charge (SOC) at C/10 (9 mA). The voltage limits of 2.8 and 1.8 V were applied to avoid overcharging and overdischarging, respectively.

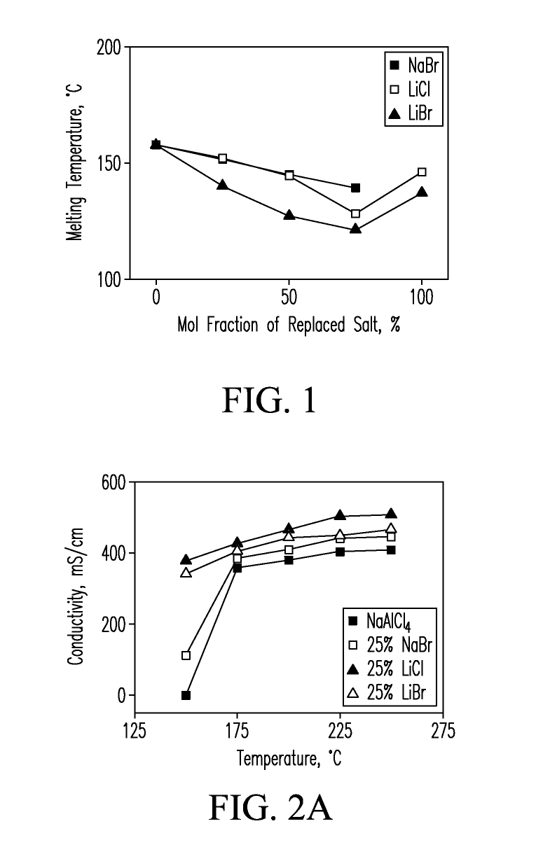

FIG. 1 shows the melting temperatures of NaAlCl₄ and various molten salt electrolytes obtained by partially replacing NaCl in NaAlCl₄ with lower melting temperature alkali metal salts. The melting temperature of secondary electrolytes containing NaBr decreases with increasing amounts of NaBr (158° C. for NaAlCl₄ and 140° C. for 75 mol % replacement). The molar ratio of [Br⁻]/[Cl⁻] in the NaCl/NaBr/AlCl₃ system corresponds to 0.23 for 75 mol % replacement of NaCl (NaBr-75). Lowering melting temperatures by partial replacement of NaCl was also observed in NaCl/LiCl/AlCl₃ and NaCl/LiBr/AlCl₃ systems.

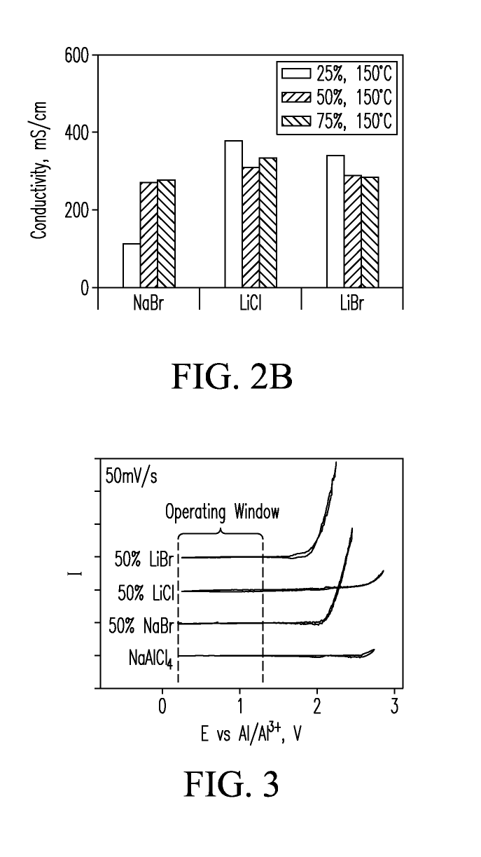

The effects on ionic conductivity from NaCl replacement with a substituting salt are shown in FIG. 2. At the temperature of 175° C. or higher, the NaCl/NaBr/AlCl₃, NaCl/LiCl/AlCl₃ and NaCl/LiBr/AlCl₃ generally have similar or higher ionic conductivity than pure NaAlCl₄. The improved ionic conductivities of the NaCl/NaBr/AlCl₃, NaCl/LiCl/AlCl₃ and NaCl/LiBr/AlCl₃ can be attributed to its lower melting temperatures (low bond polarity) and more irregular structures of molten salts allowing easier ion hopping. The positive effects of NaCl replacement on the ionic conductivity are most obvious at 150° C. at which NaAlCl₄ exists as a solid. As shown in FIG. 2(b), NaCl-replaced secondary electrolytes exhibited good ionic conductivity at 150° C. NaBr-25, which contained 25 mol % NaBr, was an exception. However, the ionic conductivity observed in this study may not necessarily represent the Na⁺ conductivity. The deviation between the total ionic conductivity and the Na⁺ conductivity can be more pronounced in the systems containing a higher fraction of Li salts due to a lower Na⁺ concentration.

The electrochemical windows of 50 mol % NaCl-replaced secondary electrolytes measured at 190° C. are shown in FIG. 3. It is known that the low voltage limit of NaAlCl₄ is set by the reduction of Al³⁺ (occurring at 0 V vs. Al/Al³⁺) while the high voltage limit is restricted by the oxidation of Cl⁻. As can be seen, the low voltage limit of various secondary electrolytes was not changed since no alternation in AlCl₃ composition was made. However, the change in the high voltage limit was observed from the secondary electrolytes with NaBr and LiBr. This is due to the lower reduction potential of Br⁻ (standard reduction potential=1.07 V) compared to that of Cl⁻ (standard reduction potential=1.36 V). The high voltage limits of all the secondary electrolytes, however, are high enough to apply these catholytes for the Na/NiCl₂ batteries, which cycle between 1.8V (0.2 V vs. Al/Al³⁺) and 2.8 V (1.2 V vs. Al/Al₃⁺) with respect to the Na/Na⁺ potential.

Na/NiCl₂ cells with one of the low melting temperature catholytes (NaBr-50: 50 mol % NaCl-replaced with NaBr) were tested and compared with a cell containing a standard NaAlCl₄ secondary electrolyte.

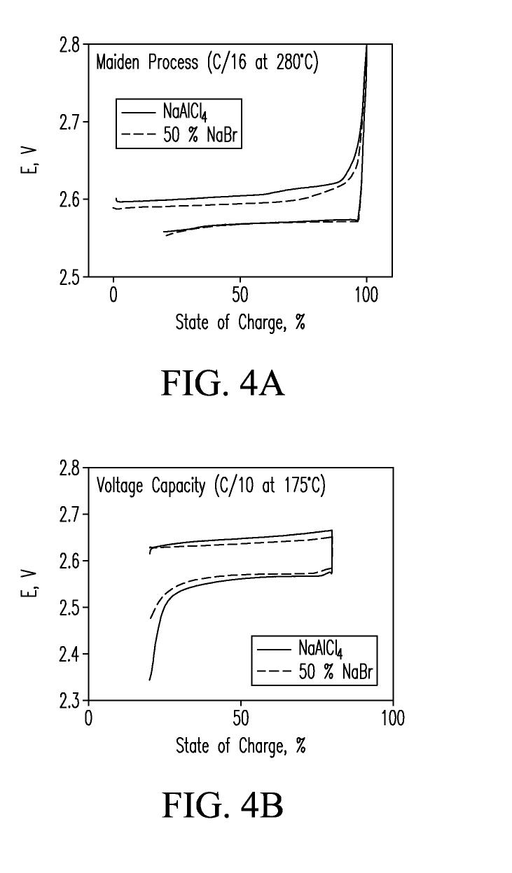

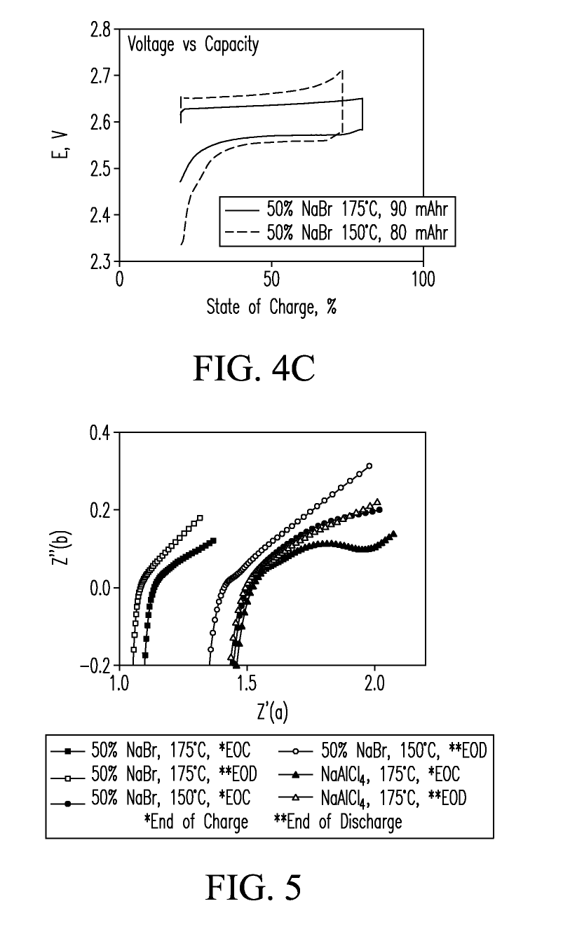

The charge/discharge profile of the NaBr-50 cell is compared with the standard NaAlCl₄ cell in FIG. 4. At 280° C., the cell with the NaBr-50 catholyte exhibited slightly smaller polarization (or lower charging potential) during charge and similar polarization during discharge (see FIG. 4a). The reduced polarization due to the use of lower melting temperature secondary electrolyte (NaBr-50) is more obvious at 175° C. as shown in FIG. 4b. Especially, the rapid polarization increase at the end of discharge (represented by a sharp drop in voltage) was significantly reduced compared to the standard NaAlCl₄ cell. This result implies that the sharp drop in voltage at the end of discharge at 175° C. is related to not only the poor wetting of molten sodium to the BASE but also the diffusion limitation of Na⁺ ions in the secondary electrolyte, which is caused by the high viscosity of NaAlCl₄ at the low temperature close to its melting point. The cell with the NaBr-50 secondary electrolyte was able to cycle even at 150° C. at which the standard NaAlCl₄ cell could not be cycled due to its high melting point of 158° C. Only a limited capacity of 80 mAh (between 20% and 73% SOC) was cycled at 150° C. due to a rapid increase in cell voltage at the end of charge (refer to FIG. 4c). This rapid increase in voltage occurring at only 73% SOC might imply that Na⁺ ion conduction in the secondary electrolyte becomes a rate limiting step especially at the end of charge where the electrochemical reaction occurs farther from the cathode/BASE interface. The sharp drop of the cell potential at the end of discharge was also much more severe at 150° C. compared to 175° C. (FIG. 4c).

FIG. 5 shows the impedance spectra of the cells with the NaBr-50 catholyte compared with the standard NaAlCl₄ cell. In all the cells, slightly lower ohmic resistance (high-frequency intercept: HFI) was observed at the end of discharge (EOD) compared to the end of charge (EOC). This can be due to the formation of the electrically less conductive NiCl₂ layer over Ni particles during the charge process. At 175° C., a significant decrease in ohmic resistance was detected in the cell containing the NaBr-50 catholyte (1.08Ω at EOC) compared to the standard NaAlCl₄ cell (1.49Ω at EOC). The ohmic resistance of the NaBr-50 cell increased at 150° C. to 1.5Ω at EOC, but it is still comparable to that of the standard NaAlCl₄ cell at 175° C. Even though exhibiting similar ohmic resistance, the NaBr-50 cell tested at 150° C. revealed larger polarization arcs compared the standard NaAlCl₄ cell tested at 175° C. Since impedance spectra did not provide complete semicircles (or low-frequency intercepts), the total cell polarization was calculated from the difference between cell potentials at the end of each step and open circuit voltage (OCV). The total cell polarizations at the end of each step and the ohmic resistance obtained from the impedance measurements are listed in Table 2.

TABLE 2
Ohmic resistances and total cell polarizations of the Na/NiCl₂ cell with the NaBr-50 catholyte at 175° C.

| | BOC* | | EOC* | | BOD* | | EOD* | |
|---|---|---|---|---|---|---|---|---|
| Catholyte | NaAlCl₄ | NaBr-50 | NaAlCl₄ | NaBr-50 | NaAlCl₄ | NaBr-50 | NaAlCl₄ | NaBr-50 |
| Ohmic | 1.49 | 1.08 | 1.52 | 1.14 | 1.52 | 1.14 | 1.49 | 1.08 |
| resistance | | | | | | | | |
| (Ω) | | | | | | | | |
| Total Cell | 5.3 | 5.3 | 9.4 | 7.8 | 1.6 | 1.2 | 26.2 | 12.2 |
| Polarization | | | | | | | | |
| (Ω) | | | | | | | | |

*BOC: beginning of charge, EOC: end of charge, BOD: beginning of discharge, and EOD: end of discharge.

At the beginning of charge (BOC) and discharge (BOD), the electrochemical reactions (Ni oxidation for charging and NiCl₂ reduction for discharging) occur near the cathode/BASE interface. Therefore, the polarizations related to charge transfer and diffusion at BOC and BOD are much smaller compared to those at the end of the charge (EOC) and discharge (EOD) since the electrochemical reactions occur far from the cathode/BASE interface at the end of each step. It is also observed that the total cell polarizations at BOC and EOD are larger than those at BOD and EOC even though the ohmic resistance is smaller. It should be noted that the cell is in discharged state in the case of BOC and EOD, while it is in the charged state for BOD and EOC. At temperatures lower than 200° C., sodium melt at the anode reveals poor wetting to the BASE. Therefore, the polarization associated with poor sodium wetting is maximized in discharged state, where the least amount of sodium melt is left during cycling.

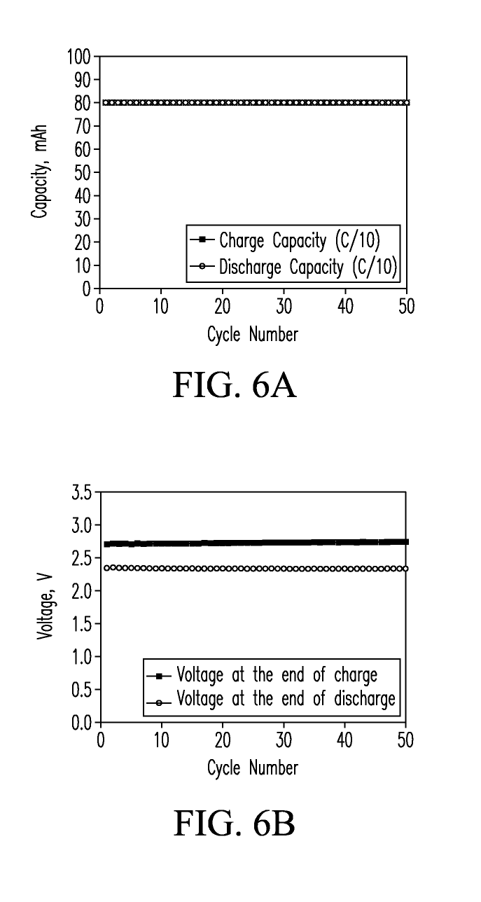

The cell performance of the battery with the NaBr-50 catholyte at 150° C. is shown in FIG. 6. No capacity degradation (FIG. 6a) and no significant change in end voltage (FIG. 6b) is observed for 50 cycles at the C/9 rate (9 mA). Overall, the stable performance of the NaBr-50 cell indicates that this secondary electrolyte is chemically stable without experiencing ion exchange of Br⁻ in the catholyte with Cl⁻ in the active cathode materials such as NaCl and NiCl₂. In the case that Br⁻-Cl⁻ ion exchange occurred, the melting temperature and the viscosity of the catholyte would have increased with time so that the polarization should have increased with cycling

While a number of embodiments of the present invention have been shown and described, it will be apparent to those skilled in the art that many changes and modifications may be made without departing from the invention in its broader aspects. The appended claims, therefore, are intended to cover all such changes and modifications as they fall within the true spirit and scope of the invention.

We claim:

1. A sodium metal-halide energy storage device having an operating temperature less than or equal to 200° C. and having a liquid secondary electrolyte comprising MₓNa_{1-y}AlCl_{4-y}H_{y}, wherein M is a metal cation of a substituting salt, H is an anion of the substituting salt, y is a mole fraction of substituted Na and Cl, and x is a ratio of y over r, where r is the oxidation state of M, and wherein the melting temperature of the substituting salt is less than that of NaCl.

2. The energy storage device of claim 1, wherein the substituting salt is NaBr

3. The energy storage device of claim 1, wherein the substituting salt is LiCl

4. The energy storage device of claim 1, wherein the substituting salt is LiBr.

5. The energy storage device of claim 1, wherein the substituting salt is selected from the group consisting of NaI, LiI, KBr, KCl, KI, CsBr, and CsI.

6. The energy storage device of claim 1, wherein the mole fraction of substituted Na and Cl is less than 0.85.

7. The energy storage device of claim 1, wherein the mole fraction of substituted Na and Cl is less than or equal to 0.75.

8. The energy storage device of claim 1, further comprising cathode and anode chambers, wherein the cathode chamber, the anode chamber, or both have seals comprising a polymer material.
